(19) United States
(12) Patent Application Publication
(10) Pub. No.: US 2004/0181468 A1
(43) Pub. Date: Sep. 16, 2004

(54) System and method of funding a charity

(76) Inventors: Richard Harmon, Lake Forest, IL (US); Stephen Townley, London (GB)

Correspondence Address: BELL, BOYD & LLOYD, LLC, PO BOX 1135, CHICAGO, IL, 60690-1135, US

(21) Appl. No.: 10/386,746

(22) Filed: Mar. 12, 2003

(51) Int. Cl. G06F 17/60

(52) U.S. Cl. 705/29; 705/1

(57) ABSTRACT

A system and method of funding a charity is provided. The system and method enable a number of buyers to purchase and resell a variety of items. Each of the items is associated with a charity and an amount related to the proceeds of each sale is donated to the charity.

### BACKGROUND OF THE INVENTION

The present invention relates to a system and method for funding at least one charity. The system and method of the invention may be used to fund any suitable charity, non-profit or philanthropic organization or individual charitable project.

Charitable organizations are almost always in need of funds. Despite the generous donations of individuals civic groups and corporations, need invariably exceeds available funds. Thus, charitable organizations are constantly seeking new sources of funding. Often the most effective charitable fund raising techniques are those that will benefit the donor in some way, or which at least provide some incentive for the donor to make a contribution beyond mere altruistic motives, in compliance with applicable tax laws. Thus, individuals may donate their used automobile to a charity in return for a tax deduction, or businesses may lend their names to charitable fundraising campaigns in order to reap the good will of consumers who thereafter associate the business name with charitable support, such as sponsoring exhibitions at museums, and the like. Or professional sports organizations and the broadcast outlets which broadcast their games may combine to create ad campaigns to be aired during games for soliciting contributions to various charities in order to burnish their public image.

Unfortunately, even with the myriad funding sources available, from the grass roots to large scale corporate giving, there still exists a tremendous need for charitable giving. Charitable organizations are continually looking for new approaches to increase donations and for ways of soliciting funds that will have the least negative impact on the donor, or which will provide some incentive that will spur more persons to donate. The system and method of the present invention provide such a new funding mechanism.

### SUMMARY OF THE INVENTION

The present invention provides a system and method of funding a charity. According to one embodiment of the present invention, the method of funding a charity includes the steps of associating at least one item with the charity and later selling the item at a first price to a first buyer. In one embodiment, at least a portion of the first price is donated to the charity.

The item is then later resold at a second price to a second buyer, the second price being greater than the first price. An amount relating to the first price is then refunded or repaid to the to the first buyer, and at least a portion of the difference between the second price and the first price is donated to the charity. In one embodiment the entire resale price is donated to the charity and no amount is repaid to the first buyer.

The method of funding the charity may further include the step of reselling the item a number of additional times at increasingly higher resale prices. Each of the immediately previous resale prices are then repaid to each respective previous buyer, with at least a portion of the difference between each of the successive resale prices and the immediately previous resale prices being donated to the charity. In one embodiment, none of the resale prices are repaid to the respective previous buyers.

According to another embodiment of the present invention, a method of funding at least one charity is provided. The method includes the steps of defining at least one item and selling the item at a first price to a first buyer. At least a portion of the first price may be donated to a charity selected by the first buyer.

The charity item is then resold at a second price to a second buyer, the second price being greater than the first price. An amount relating to the first price is then refunded or repaid to the first buyer, and at least a portion of the difference between the second price and the first price is donated to a charity selected by the second buyer. In an alternative embodiment, nothing is refunded to the first buyer and all of the proceeds go to the charity.

The method of funding at least one charity may further include the step of reselling the item a number of additional times at increasing resale prices. An amount related to each of the immediately previous resale prices is then repaid to each respective previous buyer, and at least a portion of the difference between each successive resale price and the immediately previous resale price is donated to a charity selected by the corresponding resale buyer. Alternatively, no payment is made to the resellers, and all of the resale proceed are donated to the charity.

According to yet another embodiment of the present invention, a method of funding a number of charities is provided. The method includes the steps of identifying a number of charities and identifying a number of sale items. Various of the identified items are then associated with various of the identified charities. The method further includes the step of displaying the items associated with a selected charity and selling at least one of the displayed items at a first price to a first buyer. In one embodiment, at least a portion of the first price is donated to the selected charity.

The displayed item is then resold at a second price to a second buyer. Preferably, the second price is greater than the first price. An amount related to the first price is then repaid or refunded to the first buyer, and at least a portion of the difference between the second price and the first price is donated to the selected charity. As with the previous embodiments, the step of refunding at least a portion of the amount paid by a reseller for the item is omitted and all of the proceeds from each resale are donated to the charity.

The method of funding the number of charities may further include the step of reselling the displayed item a number of additional times at a resale price with each successive resale price being greater than an immediately previous resale price. An amount related to each of the immediately previous resale prices is then repaid to each respective previous buyer, and at least a portion of the difference between each of the successive resale prices and the immediately previous resale prices is donated to the selected charity.

According to still another embodiment of the present invention, a system for funding at least one charity is provided. The system includes a number of buyer/seller computers for purchasing items associated with a charity, and at least one exchange computer. The seller computer and the buyer/seller computers are interconnected by a computer network.

The exchange computer is programmed to display items associated with a charity selected by a first buyer/seller and to sell at least one of the displayed items at a first sale price to a first buyer. In one embodiment, at least a portion of the first sale price is donated to the selected charity.

The exchange computer is further programmed to facilitate the resale of the item from the first buyer to a second buyer at a second price, the second price being greater than the first price. The exchange computer is further configured to repay an amount related to the first price to the first buyer, and to donate at least a portion of the difference between the second price and the first price to the selected charity. If desired, the amount repaid to the first buyer may be reduced to zero in order to increase the amount donated to the charity.

The exchange computer may be further programmed to facilitate the resale of the item a number of additional times at successively higher resale prices. In addition, the exchange computer may be programmed to repay an amount related to each of the immediately previous resale prices to each respective previous buyer, and to donate at least a portion of the difference between each successive resale price and the immediately previous resale price to the selected charity. In the alternative, no amount is repaid to each of the respective previous buyers and substantially all of the proceeds from each additional resale are donated to the selected charity.

Additional features and advantages of the present invention are described in, and will be apparent from, the following Detailed Description of the Invention and the Figures.

### BRIEF DESCRIPTION OF THE FIGURES

FIG. 1 is a block diagram showing a system for funding at least one charity according to an embodiment of the present invention.

FIG. 2 is a flowchart illustrating a method of funding a charity according to an embodiment of the present invention.

FIG. 3 is a flowchart illustrating a method of funding at least one charity according to an embodiment of the present invention.

FIG. 4 is a flowchart illustrating a method of funding a number of charities according to an embodiment of the present invention.

FIG. 5 is a computer display according to the embodiment of the invention showing multiple sale items associated a number of different charities.

### DETAILED DESCRIPTION OF THE INVENTION

The present invention relates to a system and method of funding a charity. In an embodiment of the invention a system for funding at least one charity is provided. The system enables buyers to purchase items and later resell them at a profit. At least a portion of the profit is then donated to a charity with which the item is associated. The item may be repeatedly resold with a portion of the resale price being donated to the charity. In various embodiments of the invention the original price paid for the item or a portion thereof is returned to the party reselling the item. In this way the purchaser's original investment in the item is recovered or at least partially offset and only the profit made on the resale of the item accrues to the charity. Thus, the reseller makes a contribution to the charity (the profit he or she would have realized from the resale of the item), but is no worse off than before he or she purchased the item. Furthermore, the final purchaser of the item receives the item while only paying what he or she believes the items is worth.

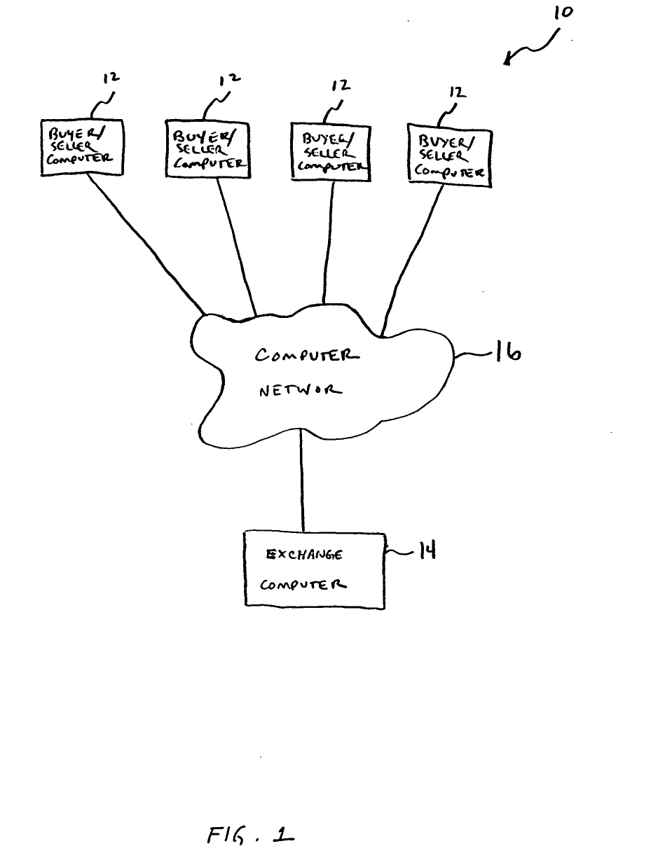

FIG. 1 shows a block diagram of a system 10 for funding at least one charity according to an embodiment of the present invention. The system 10 includes a number of buyer/seller computers 12 and at least one exchange computer 14. The buyer/seller computers 12 are the computers of individual participants in an electronic marketplace established by system 10. At any given time a buyer/seller computer 12 may switch roles between buying and selling items depending on the type of transaction the user desires to enter. The buyer computers 12 and the seller computers 13 are interconnected to the exchange computer 14 by a computer network 16. The computer network 16 may be a public computer network such as the Internet, or a private network to which buyers must subscribe in order to gain access to the exchange computer 14. Alternatively, the network 16 could be any computer network suitable for allowing a plurality of buyers and sellers to access an electronic marketplace for trading items that have been associated with a charity.

In a preferred embodiment of the invention the exchange holds the inventory of items being traded. Users buy and sell items, but do not necessarily take physical possession of an item after it is purchased. In an embodiment of the invention an item being traded is delivered only after a predefined trading period has expired. In this embodiment the item is delivered to the user who last purchased the item prior to the close of the trading period. Furthermore, the items being traded may be intangible items such as event tickets, or simply the access rights associated with event tickets, personal seat licenses for attending sporting events, season tickets for sporting or other events, or contingent events certificates. (Contingent event certificates are disclosed in U.S. patent application Ser. No. 10/179,634, the disclosure of which is incorporated herein by reference.) A contingent event certificate grants the right and confers the obligation to the holder of the certificate to purchase a ticket for an event that may be scheduled in the future, in the event that the event is in fact later scheduled.

The function of funding a charity or a group of charities is ancillary to the primary function of trading items in system 10. Preferably the items traded on the system 10 are in relatively high demand and available in sufficient quantities to sustain a robust market in such items. The initial supplier of the items, be it the original manufacturer, a distributor, an event promoter, a sports franchise owner, auction house or the like, places items for sale on the system 10. Once the items have been placed for sale on the market the exchange computer 14 controls the inventory at all times. The exchange may physically take control of the inventory or may merely control how and when it is distributed.

Once inventory has been placed for sale on the market the exchange computer 14 creates a description of the items offered which may be sent to and displayed by the various buyer/seller computers 12. The description of the items may include a current market price, as well the best current bid and best current offer for the items, or a list of recent bids and offers, and so forth. Buyers can purchase items by accepting offers or by placing bids in hopes that a seller (one who has already acquired ownership of one or more items) will except the bid. Similarly, sellers may sell items by accepting bids and placing offers in hopes that their offer will be accepted. Of course, since the initial supplier is the original owner of all the inventory, the first transaction involving an item will be the sale of the item from the initial supplier to the first buyer on the open market.

As with any market, the law of supply and demand will set the market price for items traded on system 10. For popular items with limited supply, prices will likely increase over time. Accordingly, users who purchased items earlier at lower prices my be enticed to sell their holdings at the new higher market price to realize a profit. According to the present invention, this profit is put to charitable purposes.

In an embodiment of the invention, the initial supplier of the items offered for sale may designate a portion of the inventory of items, or the entire inventory, as being associated with a designated charity. When these designated items are traded a portion or all of the profits associated therewith are earmarked for the charity. The exchange computer 14 may be configured such that each time a seller re-sells an item, he or she is refunded his or her initial investment in whole or in part, and only the profits in excess of the seller's purchase price are sent to the charity. Additionally, the initial supplier of the items may opt to donate all or a portion of the initial sale price of the items to the charity. In these circumstances a significant portion of the final sale price of an items will be donated to the charity.

A brief example of the present invention operating in a specific market to raise money for a charitable cause illustrates the potential of the present invention to provide charitable organizations with a significant new revenue stream as well as garnering significant goodwill for the supplier who initially supplies the sale items which are associated with the charity. The present invention is especially well suited for application in primary and secondary markets for live event tickets such as sporting event tickets, concert tickets and other live event tickets. Take sporting events. A franchise owner may opt to sell tickets for a particular game on the system 10. Further, the owner may designate a specific block of tickets to be associated with a selected charity. Thereafter, each trade involving the designated tickets will be donated to the specified charity. The designated tickets will be advertised as being associated with the specific charity on the display pages generated by the exchange computer 14 and distributed over the network 16 for display on the buyer/seller computes 12. Thus, users who wish to contribute to the charity may chose to trade in the tickets to the game which have been associated with the charity rather than tickets to the same game which have not been associated with the charity. Furthermore, any one browsing the exchange to examine the market for tickets to the game will be aware that the franchise owner is involved with the charity, thereby generating a positive image for the owner in the community.

The franchise owner may elect to donate all or part of the initial sale price of the designated tickets to the charity. Thus, if the ticket initially sells for $50, the charity will receive at least a portion of that amount regardless of whether or not the ticket is ever resold. However, if the ticket is in fact resold, at least a portion of the additional profit from each additional transaction is also donated to the charity. In order to make such secondary and tertiary transactions more attractive to the sellers, at least a portion of the purchase price paid by the reseller for obtaining the ticket is returned to the seller upon the subsequent resale of the ticket. Thus, the user who first purchased a designated ticket from the franchise over for $50 and later sells the ticket for $75 due to rising demand, will receive a refund which is equal to significant portion of his or her initial $50 investment, while the charity will receive all or part of the $25 difference between the $75 paid by the second buyer and the $50 paid by the first buyer. The $25 paid to the charity is revenue lost to the reseller, but it is merely a paper loss. Returning a significant portion of the seller's initial investment places the seller in substantially the same position that he or she occupied prior to purchasing the ticket. The lost profit is the seller's donation to the charity. Designated tickets may be sold and resold any number of times prior to the event, with all of the additional profit accruing to the charity. The final purchaser of the event ticket also benefits in that he or she is enabled to attend the game or event knowing that a significant portion of the price he or she paid for the ticket was donated to charity.

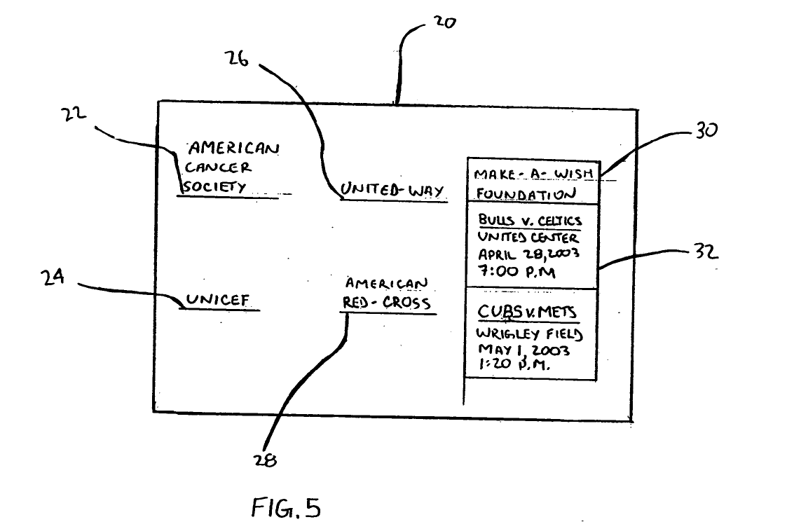

The buyer/seller computers 12 are suitable for operation by buyers and sellers desiring to purchase and trade items associated with a charity. To assist the buyers in purchasing these items, the exchange computer 14 is programmed to generate and distribute a display page which may be displayed on the buyer/seller computers 12. An example of such a page is shown in FIG. 5. The display page 20 lists a number of charities such as the American Cancer Society 22, UNICEF 24, the United Way 26, Amnesty International 28, and Make-A-Wish Foundation 30, as shown in FIG. 5. A user browsing the display page 20 may select a particular charity which he or she is interested in by, for example mouse clicking the particular charity of interest. By mouse clicking on the charity a list of items for sale which have been associated with the charity is displayed. In the example shown, a user has selected the Make-A-Wish Foundation 30, and a list of sporting events for which a number of tickets have been associated with the Make-A-Wish Foundation is displayed. The user may then select an event of particular interest in order to view the current market for the designated charitable tickets to the selected event. From the displays market page (not shown) the user may then buy or sell tickets to the event which have been associated with the Make-A-Wish Foundation, and the proceeds from such trading will be donated as has been described.

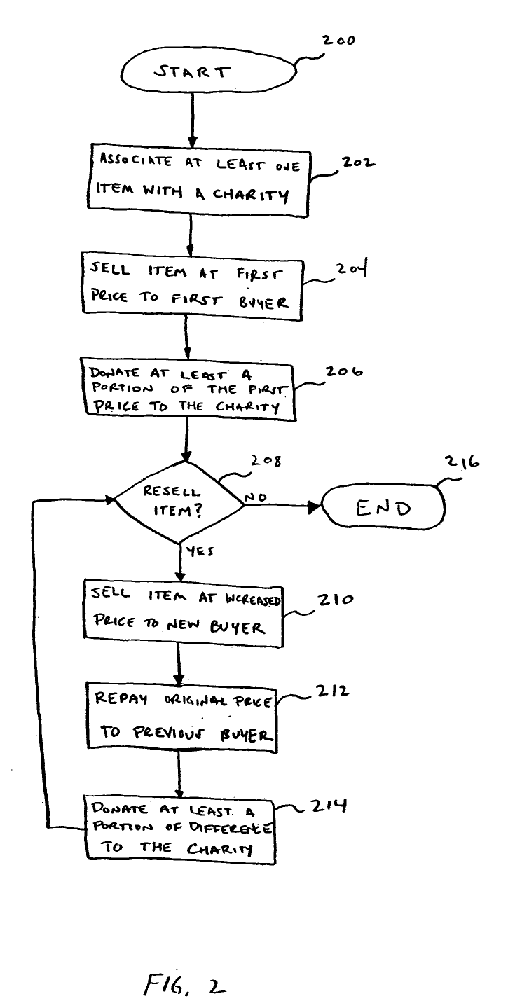

A flow chart depicting a method of funding a charity according to an embodiment of the present invention is shown in FIG. 2. The method starts at step 200. At least one item is associated with a charity at step 202. As described above, the item associated with the charity may be any suitable item for which there is sufficient demand to support market trading in the item. The charity with which the item is associated may be any suitable charitable organization of the initial supplier's choosing.

The item associated with the charity is then sold at a first price to a first buyer as indicated by step 204. In an embodiment of the invention, the money collected for the first sale is donated by the initial supplier of the item to the charity as shown in step 206. Alternatively, only a portion of the initial sale price is donated, allowing the supplier of the item to recoup costs associated with the original sale, or step 206 may be omitted altogether.

The method then proceeds to step 208 where a determination is made as to whether the first purchaser decides to resell the item at a higher price. If the item is to be resold at a higher price the method proceeds to step 210 where the subsequent transaction occurs. Then, in step 212 the original price paid by the previous buyer is refunded or repaid to the previous buyer. Thus, where the item is resold at a second price to a second buyer, the first price paid for the item by the first buyer is repaid to the first buyer. In alternative embodiments only a portion of the original purchase price is returned to the first purchaser, or nothing at all. In these embodiments the charity keeps more money, but there is less incentive for buyers and sellers to enter the market.

At step 214, at least a portion of the difference between the resale price and the previous price paid for the item is donated to the charity. Thus, where the item is resold at the second price to the second buyer, then at least a portion of the difference between the second price and the first price is donated to the charity.

Following step 214 the method proceeds back to step 208 where it is again determined whether the new owner desires to resell the item. If not the method ends at 216. If the item is to be resold, then the method again proceeds to step 210 as described above. It should be appreciated that after the method ends, the item is either delivered to or otherwise made accessible to the final buyer.

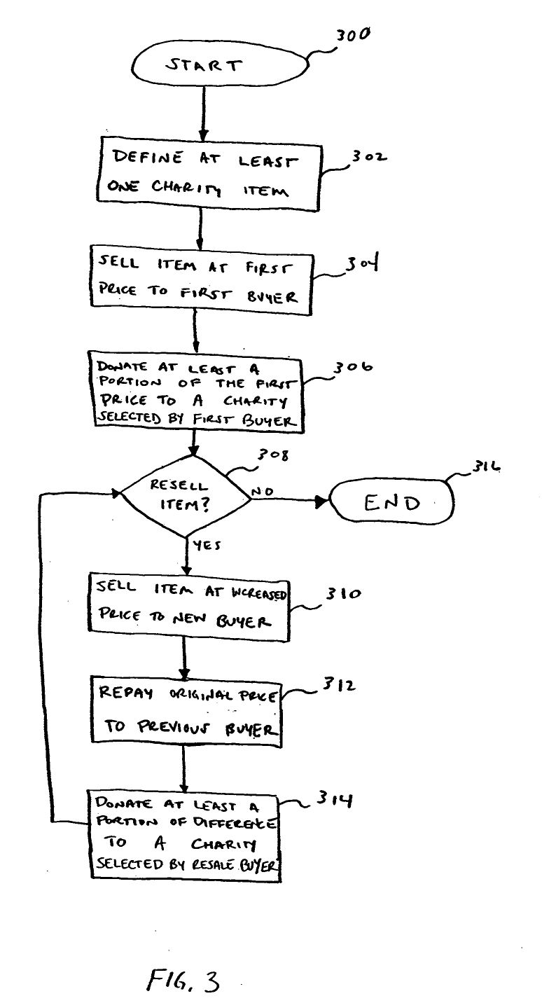

FIG. 3 illustrates a similar method of funding at least one charity according to another embodiment of the present invention. This method starts at step 300. At step 302 rather than associating an item with a specific charity, an item is merely designated as a charity item. As in the previous embodiment the charity item may include any suitable item that a buyer may desire to purchase.

The charity item is subsequently sold at a first price to a first buyer as indicated by block 304. As with the previous embodiment at least a portion of the first price is donated to a charity. However, rather than being donated to a charity designated by the initial supplier of the item, the proceeds are donated to a charity selected by the first buyer as indicated by step 306. Alternatively, step 306 may be omitted.

At step 308, it is determined whether the charity item is to be resold. If the item is to be resold, then the item is sold at an increased price to the next buyer as illustrated by step 310. In one embodiment, the original price paid by the previous buyer or a portion of the previous price is refunded or repaid to the previous buyer as indicated by step 312. Thus, where the item is resold at a second price to a second buyer, then all or part the first price would be repaid to the first buyer at step 312.

At step 314, at least a portion of the difference between the resale price and the previously paid price is donated to a charity selected by the resale buyer. Thus, where the item is resold at the second price to the second buyer, then at least a portion of the difference between the second price and the first price would be donated to a charity selected by the second buyer. However, it should be appreciated that step 312 may be omitted in alternative embodiments, thereby increasing the amount of the funds donated to the charity selected by the resale buyer at step 314.

After donating the money or funds to the charity at step 314, the method proceeds back to step 308 where it is again determined whether the new owner wants to resell the charity item. If the charity item is to be resold, then the method again proceeds through steps 310, 312, and 314 as described above. However, if the charity item is not being resold, then the method ends as indicated at step 316. After the final resale when the method ends at step 316, the item is either delivered to or otherwise made accessible to the final buyer.

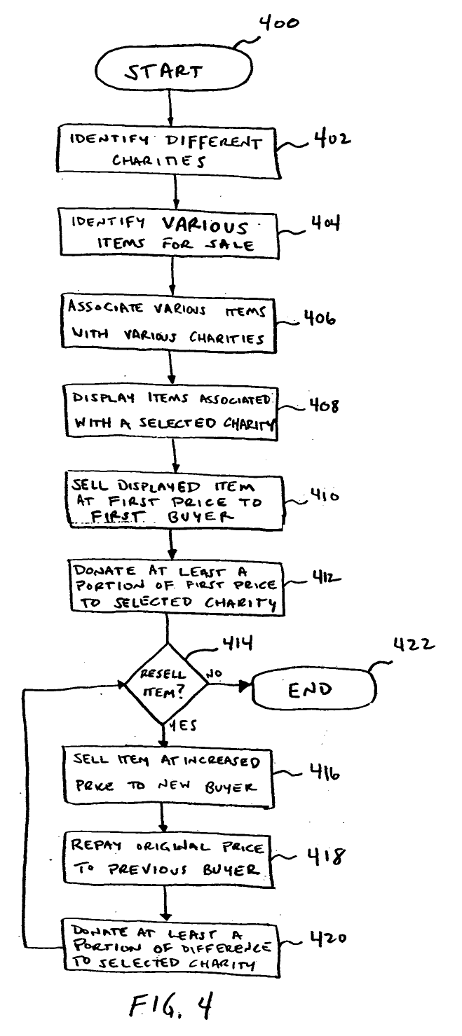

FIG. 4 illustrates yet another method of funding a charity. In this case a method is provided for funding a number of different charities. The method starts at step 400. At step 402 a number of different charities which are to be funded are identified. As described above, the charities may include any suitable charitable organizations or foundations. In addition to identifying the charities, a number of items for sale are also identified as indicated step 404. Again, items include any suitable items for which suitable demand exists to establishing a market.

After the charities and the items have both been identified, the various items are associated with various charities as indicated by step 406. For proper allocation of the funds generated by the sale and resale of the items among the charities, the items must be associated with the charities on a one-to-one basis. By way of illustration, assume that twenty hockey tickets and twenty basketball tickets are identified in step 404 while three charities, the American Heart Association, the American Red Cross and the American Lung Association, are identified in step 402. Step 406 amounts to associating a first ten hockey tickets with the American Heart Association, and the second 10 hockey tickets with the American Lung Association, whereas all ten basketball tickets are associated with the American Red Cross. No individual ticket is associated with more than one charity. Thus, funds raised through the sale of the first ten hockey tickets would benefit the American Heart Association while funds raised through the sale of the second ten hockey tickets would benefit the American Lung Association and the funds generated through the sale of all of the basketball tickets would benefit the American Red Cross.

After the various identified items have been associated with the respective identified charities, items associated with a particular charity may be displayed when the corresponding charity is selected for display on a display device as illustrated by step 408. Using the above example, if a buyer were to select the American Lung Association, then the corresponding ten hockey tickets would be displayed. In this regard, it should be appreciated that the items could be grouped for sale or they could be sold individually. In addition, it should be appreciated that more than one type of item may be associated with a given charity. Thus, both basketball and hockey tickets might be associated with the American Red Cross.

One of the displayed items is then sold to a first buyer at a first price as indicated by step 410. In one embodiment, at least a portion of the first price is donated to the selected charity as indicated by step 412. However, in an alternative embodiment, step 412 may be omitted.

At step 414, a determination is made as to whether the item is to be resold. If the item is to be resold, then the item is sold at an increased price to a new purchaser as illustrated by step 416. In one embodiment, the original price paid by the previous buyer or a portion of the original price is refunded or repaid to the previous buyer as indicated by step 418. Thus, where the item is resold at a second price to a second buyer, then all or part of the first price paid by the first buyer is repaid to the first buyer at step 418.

At step 420, at least a portion of the difference between the resale price and the previous price paid for the item is donated to the charity with which the particular item is associated. Thus, where the item is resold at the second price to the second buyer, then at least a portion of the difference between the second price and the first price would be donated to the selected charity. However, it should be appreciated that step 418 may be omitted in various alternative embodiments. This has the effect of increasing the amount of funds donated to the selected charity at step 420, but reduces the incentive for users to participate in the program.

After donating the money or funds to the charity at step 420, the method proceeds back to step 414 where it is again determined whether the item is to be resold. If the item is to be resold, then the method proceeds as described above. However, if the item is not being resold, then the method ends as indicated by step 422.

It should be appreciated that after the method ends, the item is either delivered or otherwise made accessible to the final buyer. For example, where the item sold is two rock concert tickets, the tickets could then be mailed to the final buyer or held at will call at the event for the final buyer.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention claimed is:

1. A method of funding a charity, comprising the steps of:
associating at least one item with the charity;
selling the item at a first price to a first buyer;
reselling the item at a second price to a second buyer, wherein the second price is greater than the first price;
repaying an amount related to the first price to the first buyer; and
donating at least a portion of a difference between the second price and the first price to the charity.

2. A method of funding a charity as claimed in claim 1, further comprising the step of donating at least a portion of the first price to the charity.

3. A method of funding a charity as claimed in claim 1, further comprising the step of reselling the item one or more times with each resale price being greater than an immediately previous sale price, an amount related to each of the immediately previous resale prices being repaid to each respective previous buyer, and at least a portion of a difference between each of the successive resale prices and the immediately previous resale prices being donated to the charity.

4. A method of funding a charity as claimed in claim 1, wherein the item is a ticket.

5. A method of funding a charity as claimed in claim 3, wherein the ticket is selected from the group consisting of event tickets and travel tickets.

6. A method of funding a charity as claimed in claim 1, wherein the item is a contingent event ticket certificate.

7. A method of funding a charity as claimed in claim 1, wherein the item is selected from the group consisting of memorabilia, personal seat licenses, hotel reservations and travel packages.

8. A method of funding a charity, comprising the steps of:
associating at least one item with the charity;
selling the item at a first price to a first buyer;
reselling the item at a second price to a second buyer, wherein the second price is greater than the first price; and
donating at least a portion of the second price to the charity.

9. A method of funding a charity as claimed in claim 8, the method further comprising the step of donating at least a portion of the first price to the charity.

10. A method of funding a charity as claimed in claim 8, further comprising the step of reselling the item further comprises the item multiple times wherein each successive resale price is greater than an immediately previous resale price, and wherein at least a portion of each resale price is donated to the charity.

11. A method of funding a charity as claimed in claim 8, wherein the item is a ticket.

12. A method of funding a charity as claimed in claim 11, wherein the ticket is selected from the group consisting of event tickets and travel tickets.

13. A method of funding a charity as claimed in claim 8, wherein the item is a contingent event ticket certificate.

14. A method of funding a charity as claimed in claim 8, wherein the item is selected from the group consisting of memorabilia, personal seat licenses, hotel reservations and travel packages.

15. A method of funding at least one charity, comprising the steps of:
defining at least one charity item;
selling the charity item at a first price to a first buyer;
reselling the charity item at a second price to a second buyer, wherein the second price is greater than the first price; and
donating at least a portion of a difference between the second price and the first price to a charity selected by the second buyer.

16. The method of funding at least one charity as claimed in claim 15, further comprising the step of repaying an amount related to the first price to the first user.

17. A method of funding at least one charity as claimed in claim 15, the method further comprising the step of donating at least a portion of the first price to a charity selected by the first buyer.

18. A method of funding at least one charity as claimed in claim 15, further comprising the step of reselling the charity item a plurality of times at successively higher resale prices, wherein an amount related to each of the immediately previous resale prices is repaid to each respective previous buyer, and at least a portion of a difference between each successive resale price and the immediately previous resale price being donated to a charity selected by each corresponding resale buyer.

19. A method of funding at least one charity as claimed in claim 15, wherein the charity item is a ticket.

20. A method of funding at least one charity as claimed in claim 19, wherein the ticket is selected from the group consisting of event tickets and travel tickets.

21. A method of funding at least one charity as claimed in claim 15, wherein the charity item is a contingent event ticket certificate.

22. A method of funding at least one charity as claimed in claim 15, wherein the charity item is selected from the group consisting of memorabilia, personal seat licenses, hotel reservations and travel packages.

23. A method of funding a plurality of charities, the method comprising the steps of:
identifying the plurality of charities;
identifying a plurality of items for sale;
associating various said items with various said charities;
displaying the items associated with a selected charity;
selling at least one of the items at a first price to a first buyer;
reselling the item at a second price to a second buyer, wherein the second price is greater than the first price; and
donating at least a portion of a difference between the second price and the first price to the selected charity.

24. The method of funding a plurality of charities as claimed in claim 23, further comprising the step of repaying an amount related to the first price to the first buyer.

25. A method of funding a plurality of charities as claimed in claim 23, further comprising the step of donating at least a portion of the first price to the selected charity.

26. A method of funding a plurality of charities as claimed in claim 23, further comprising the step of reselling the item a plurality of additional times at a resale price with each successive resale price being greater than an immediately previous resale price, an amount related to each of the immediately previous resale prices being repaid to each respective previous buyer, and at least a portion of a difference between each of the successive resale prices and the immediately previous resale prices being donated to the selected charity.

27. A method of funding a plurality of charities as claimed in claim 23, wherein the plurality of items include tickets.

28. A method of funding a plurality of charities as claimed in claim 27, wherein the tickets are selected from the group consisting of event tickets and travel tickets.

29. A method of funding a plurality of charities as claimed in claim 23, wherein the plurality of items include contingent event ticket certificates.

30. A method of funding a plurality of charities as claimed in claim 23, wherein the plurality of items include items selected from the group consisting of memorabilia, personal seat licenses, hotel reservations and travel packages.

31. A system for funding at least one charity, comprising:
a plurality of buyer and seller computers for operation by buyers and sellers desiring to buy and sell items associated with a charity; and
at least one exchange computer, the exchange computer and the plurality of buyer and seller computers being interconnected by a computer network, the exchange computer being programmed to display items associated with a charity selected by a first buyer, sell at least one of the items at a first price to the first buyer, resell the item at a second price to a second buyer, wherein the second price is greater than the first price, repay an amount related to the first price to the first buyer, and donate at least a portion of a difference between the second price and the first price to the selected charity.

32. A system for funding at least one charity as claimed in claim 31, wherein the exchange computer is further programmed to donate at least a portion of the first price to the selected charity.

33. A system for funding at least one charity as claimed in claim 31, wherein the seller computer is further programmed to resell the item a plurality of additional times at a resale price with each successive resale price being greater than an immediately previous resale price, repay an amount related to each of the immediately previous resale prices to each respective previous buyer, and donate at least a portion of a difference between each of the successive resale prices and the immediately previous resale price to the selected charity.

34. A system for funding at least one charity as claimed in claim 31, wherein the item is a ticket.

35. A system for funding at least one charity as claimed in claim 31, wherein the ticket is selected from the group consisting of event tickets and travel tickets.

36. A system for funding at least one charity as claimed in claim 31, wherein the item is a contingent event ticket certificate.

37. A system for funding at least one charity as claimed in claim 31, wherein the item is selected from the group consisting of memorabilia, personal seat licenses, hotel reservations and travel packages.
